(19) United States
(12) Patent Application Publication
(10) Pub. No.: US 2015/0315504 A1
(43) Pub. Date: Nov. 5, 2015

(54) Arc-Produced Gas Mixed with other Gases

(71) Applicant: MAGNEGAS CORPORATION, Tarpon Springs, FL (US)

(72) Inventor: Ermanno Santilli, Clearwater, FL (US)

(73) Assignee: MAGNEGAS CORPORATION, Tarpon Springs, FL (US)

(21) Appl. No.: 14/703,220

(22) Filed: May 4, 2015

Related U.S. Application Data
(60) Provisional application No. 61/988,370, filed on May 5, 2014.

(51) Int. Cl. C10L 3/00; C10L 1/00; B01J 19/08; C10L 3/06

(52) U.S. Cl. CPC C10L 3/003; C10L 3/06; C10L 1/00; B01J 19/088; C10L 2200/0415; C10L 2270/08; C10L 2290/04; C10L 2290/30; C10L 2290/38; C10L 2290/46; C10L 2290/24; B01J 2219/0809; B01J 2219/0894; B01J 2219/0877

(57) ABSTRACT

A system for producing a hybrid gas includes a pressure vessel containing in its interior a feedstock with at least one set of electrodes between which an electric arc is formed. The at least one set of electrodes is within the pressure vessel and submerged in the feedstock. A fluid system passes the feedstock through a plasma of the electric arc, thereby converting a portion of the feedstock into an arc-produced gas. The arc-produced gas is collected and mixed with at least one supplementary fluid to produce the hybrid gas.

### CROSS-REFERENCE TO RELATED APPLICATION

This application claims the benefit of U.S. provisional application No. 61/988,370 filed on May 5, 2014, the disclosure of which is incorporated by reference.

### FIELD

This invention relates to the field of combustible fluids and more particularly to a system, method and apparatus for combining an arc-produced fluid with another fluid.

### BACKGROUND

Systems are known for the production of a combustible fluid, herein called Magnegas. In general, such systems expose a feedstock to a submerged electric arc, typically under pressure, thereby producing a gas (Magnegas) which percolates and collects above the feedstock for collection. Examples of fully operational systems for the production of Magnegas can be found in U.S. Pat. No. 7,780,924 issued Aug. 24, 2010, U.S. Pat. No. 6,183,604 issued Feb. 6, 2001, U.S. Pat. No. 6,540,966 issued Apr. 1, 2003, U.S. Pat. No. 6,972,118 issued Dec. 5, 2005, U.S. Pat. No. 6,673,322 issued Jan. 6, 2004, U.S. Pat. No. 6,663,752 issued Dec. 16, 2003, U.S. Pat. No. 6,926,872 issued Aug. 8, 2005, and U.S. Pat. No. 8,236,150 issued Aug. 7, 2012, all of which are incorporated by reference.

The unique properties of the resulting gas (Magnegas) are well known and have been used in many applications including welding, cutting, propulsion, co-combustion, etc. It has been shown that such gas (Magnegas) burns hotter and cleaner than competing gases having similar compositions but manufactured in other ways.

For some applications, different burn characteristics are needed, or, in certain situations, the cost of producing the arc-produced fluid is cost prohibitive for certain applications. For example, using a gas produced by an arc submerged in vegetable oil provides for efficient and clean operation of a motor vehicle, but production of such gas is, at time, not economical due to the cost of making/acquiring the vegetable oil or due to the difficulty in collecting used vegetable oil. Yet, such gas is known to efficiently power a motor vehicle while greatly reducing emissions and pollutants. By creating a hybrid gas by mixing the arc-produced gas with, for example, propane or natural gas, this hybrid gas has similar efficiency and clean burning characteristics as the arc-produced gas while having a lower cost, closer to the cost of the propane or natural gas.

What is needed is a composite fluid made by mixing an arc-produced gas with another fluid and a system and method for producing such.

### SUMMARY

A system for producing a hybrid gas includes a pressure vessel containing in its interior a feedstock with at least one set of electrodes between which an electric arc is formed. The at least one set of electrodes is within the pressure vessel and submerged in the feedstock. A fluid system passes the feedstock through a plasma of the electric arc, thereby converting a portion of the feedstock into an arc-produced gas. The arc-produced gas is collected and mixed with at least one supplementary fluid to produce the hybrid gas.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of an exemplary system for production of a hybrid fluid.

FIG. 2 illustrates a schematic view of an exemplary controller of a system for production of the hybrid fluid.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Throughout this description, the system 5 for production of a hybrid fluid 39 is described as a system for arc-producing of a gas that is then combined with a supplementary fluid. For simplification, the supplementary fluid is a single fluid such as liquid propane, liquid natural gas, hydrogen, acetylene, etc., but any supplementary fluid or combination of supplementary fluids is anticipated. For example, the other fluid is a flammable fluid. In another example, the other fluid is not a flammable fluid.

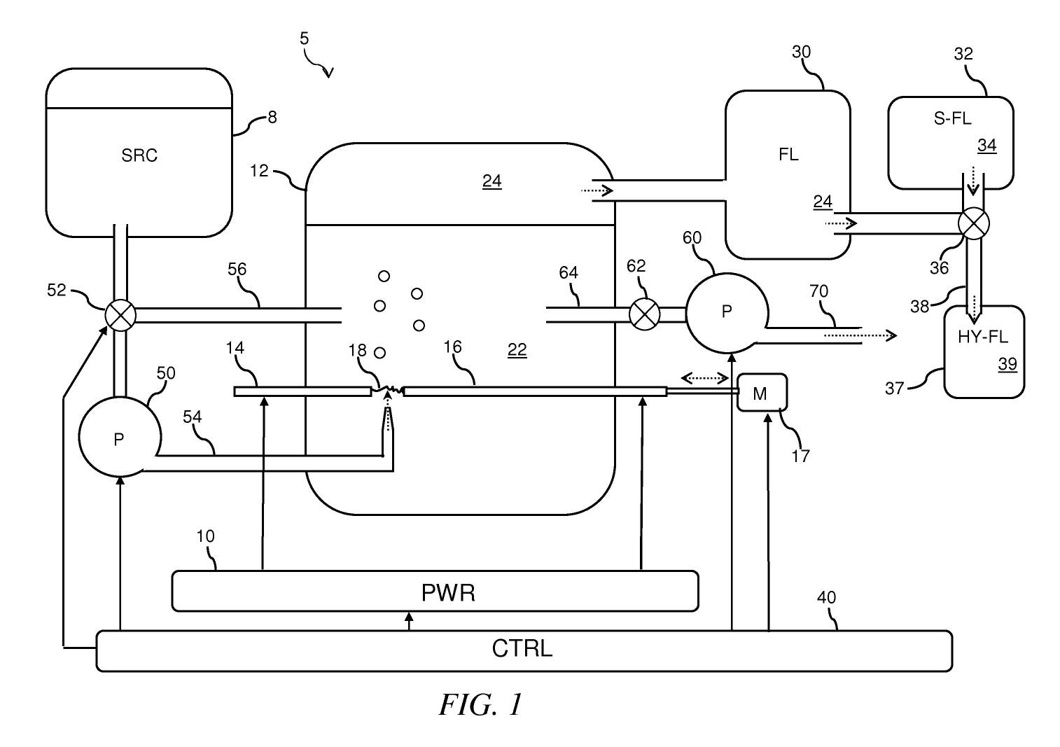

Referring to FIG. 1, an exemplary system 5 for production of a hybrid fluid 39 is shown. The system 5 starts with exposing a feedstock 8 to a plasma 18 of an electric arc. The feedstock 8 is pumped through a valve 52 by a feed pump 50 and into the reactor 12. The electrodes 14/16 and plasma 18 of the arc are submerged within the feedstock 22. In some embodiments, the feedstock is circulated within the reactor 12 and re-injected into the plasma 18 of the electric arc between the two electrodes 14/16 as discussed in U.S. Pat. No. 7,780,924 issued Aug. 24, 2010, U.S. Pat. No. 6,183,604 issued Feb. 6, 2001, U.S. Pat. No. 6,540,966 issued Apr. 1, 2003, U.S. Pat. No. 6,972,118 issued Dec. 6, 2005, U.S. Pat. No. 6,673,322 issued Jan. 6, 2004, U.S. Pat. No. 6,663,752 issued Dec. 16, 2003, U.S. Pat. No. 6,926,872 issued Aug. 9, 2005, and U.S. Pat. No. 8,236,150 issued Aug. 7, 2012. The plasma 18 causes the feedstock 22 to react, creating an arc-produced gas of a composition that depends upon the composition of the feedstock 22 and the composition of the electrodes 14/16 used in the arc.

Any feedstock 22 is anticipated either in fluid form or fluid mixed with solids such as fine-grain metal dust as found in used motor oil, etc. The arc-produced gas 24 from this process is typically combustible and the composition of the gas 24 is dependent upon the fluid base of the feedstock 22 and the composition of the electrodes 14/16.

In examples in which the feedstock 22 is a petroleum-based liquid, the exposure of this petroleum-based feedstock 22 to the arc (as above) results in an arc-produced gas 24 that includes polycyclic aromatic hydrocarbons which, in some embodiments, are quasi-nanoparticles that are not stable and, therefore, some of the polycyclic aromatic hydrocarbons will form/join to become nanoparticles or a liquid. Therefore, some polycyclic aromatic hydrocarbons as well as some carbon particles/nanoparticles are present in the resulting arc-produced gas 24. In some embodiments, some of the carbon particles or nanoparticles are trapped or enclosed in poly cyclic bonds. Analysis of the arc-produced gas 24 typically includes polycyclic aromatic hydrocarbons that range from C6 to C14. The presence of polycyclic aromatic hydrocarbons as well as carbon particles or nanoparticles contributes to the unique burn properties of the resulting arc-produced gas 24. This leads to higher burning temperatures of the arc-produced gas 24.

In another example, the feedstock 22 is used motor oil and at least one of the electrodes 14/16 is carbon. In this, the petroleum molecules separate within the plasma of the electric arc 18 into an arc-produced gas 24 that includes hydrogen (H₂) and aromatic hydrocarbons, which percolate to the surface of the petroleum liquid feedstock 22 for collection. In some embodiments, the arc-produced gas 24 made by this process includes suspended carbon particles since at least one of the electrodes of the arc 18 is made from carbon and serves as the source for the charged carbon particles or nanoparticles that travel with the manufactured hydrogen and aromatic hydrocarbon gas 24 and are collected along with, for example, the hydrogen and aromatic hydrocarbon molecules, thereby changing the burning properties of the resulting arc-produced gas 24, leading to a hotter flame. In this example, if the feedstock 22 is used motor oil and the collected arc-produced gas 24 includes any or all of the following: hydrogen, ethylene, ethane, methane, acetylene, and other combustible gases to a lesser extent, plus suspended charged carbon particles or nanoparticles that travel with these gases.

The arc-produced gas 24 is shown being collected in a tank 30 for later mixing with one or more fluids/gases 34.

In operation, the circulation valve 52 is set to open by the controller 40, connecting the source of feedstock 8 to the pump 50 and the pump 50 is controlled to operate and fill the reactor 12 to a certain level with feedstock 22. As the process continues, it is anticipated that the above is repeated as the feedstock 22 depletes, e.g., as the arc-produced gas 24 is produced. Note, at this time the exit valve 62 is closed so that no feedstock 22 exits the reactor 12.

Once sufficient feedstock 22 is within the reactor 12, the valve 52 is controlled by the controller 40 to circulate and the feedstock 22 is pumped from the reactor 12 through a feed pipe/tube 56 and back out through an injection pipe 54 by the circulation pump 50. This flow is directing the circulation of feedstock 22 directly into the plasma 18 of the arc between the electrodes 14/16. In some embodiments, the flow of the feedstock 22 is directed through one or both of the electrodes 14/16 for a more complete exposure of the feedstock 22 to the plasma 18.

As the feedstock 22 is exposed to the plasma 18 of the arc, arc-produced gas 24 is made and percolates to the top of the reactor 12, above the feedstock 22.

In some embodiments, when sufficient feedstock 22 has been exposed to the plasma 18 of the arc or the feedstock 22 is no longer useable (e.g. becomes too viscous), the exit valve 62 is opened and the exit pump 60 is operated to pump some or all of the processed feedstock 22 out of the reactor through an exit pipe/tube 64 and drain 70. The above process is repeated to refill the reactor 12 with fresh feedstock 22.

As the arc-produced gas (fluid) 24 is produced, it is stored in a tank 30 for later use/mixing. In some embodiments, the arc-produced gas 24 is compressed or processed as known in the industry to convert the arc-produced gas 24 into a liquid 24 (liquefaction). The arc-produced gas (or liquid) 24 is then mixed by a mixing valve system 36 with a supplementary fluid 34 (gas or liquid) from a second fluid storage tank 32 to produce the hybrid fluid (gas or liquid) 39. Although a single secondary storage tank 32 is shown, it is fully anticipated that any number of secondary storage tanks 32 having the same supplementary gas (or liquid) 34 or having a multitude of different supplementary gases (or liquids) 34. Any single or multiple supplementary gas or liquid 34 is anticipated such as Propane (liquid or gas), Propylene, Natural gas, methylacetylene (propyne) and propadiene, naptha, synthetic natural gas, liquid hydrogen, etc.

It is anticipated that the hybrid fluid 39 comprise any proportion of arc-produced fluid 24 to supplementary fluid(s) 34 including, but not limited to, at least 10% of the arc-produced fluid 24, approximately 10% of the arc-produced fluid, approximately 50% of the arc-produced fluid, etc. As a non-limiting example, one hybrid fluid 39 comprises 50% liquefied arc-produced fluid 24, 25% of propane, and 25% of natural gas, by volume. The resulting hybrid gas 39 is, for example, stored in another tank 37 or used immediately.

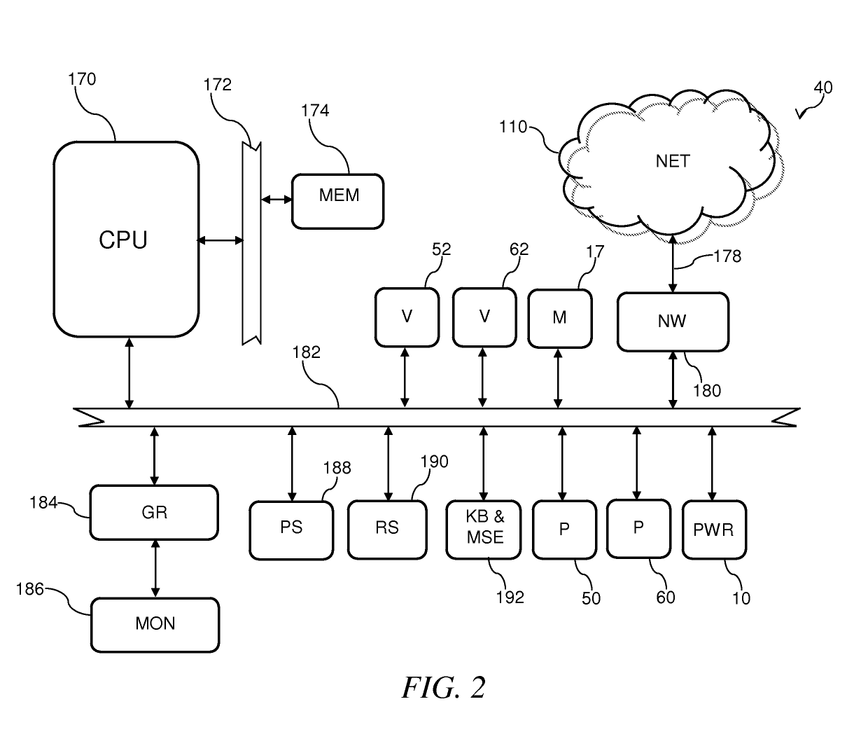

Referring to FIG. 2, a schematic view of an exemplary controller 40 of a system 5 for producing a hybrid fluid 39 is shown. This example computer system 40 represents a typical computer system 40 used to control various aspects of the system for producing the hybrid fluid 39. The example computer system 40 is shown in its simplest form, having a single processor. Many different computer architectures are known that accomplish similar results in a similar fashion and the present invention is not limited in any way to any particular computer system. The present invention works well utilizing a single processor system, as shown in FIG. 2, a multiple processor system where multiple processors share resources such as memory and storage, a multiple server system where several independent servers operate in parallel (perhaps having shared access to the data or any combination). In any of these systems, a processor 170 executes or runs stored programs that are generally stored for execution within a memory 174. The processor 170 is any processor or a group of processors, for example an Intel Pentium-4® CPU or the like. The memory 174 is connected to the processor by a memory bus 172 and is any memory 174 suitable for connection with the selected processor 170, such as SRAM, DRAM, SDRAM, RDRAM, DDR, DDR-2, etc. Also connected to the processor 170 is a system bus 182 for connecting to peripheral subsystems such as a network interface 180, persistent storage (e.g. a hard disk) 188, removable storage (e.g. DVD, CD, flash drive) 190, a graphics adapter 184 and a keyboard/mouse 192. The graphics adapter 184 receives commands and display information from the system bus 182 and generates a display image that is displayed on the display 186.

In general, the persistent storage 188 is used to store programs, executable code and data such as user financial data in a persistent manner. The removable storage 190 is used to load/store programs, executable code, images and data onto the persistent storage 188. These peripherals are examples of input/output devices 180/184/192, persistent storage 188 and removable storage 190. Other examples of persistent storage include core memory, FRAM, flash memory, etc. Other examples of removable media storage include CDRW, DVD, DVD writeable, Blu-ray, compact flash, other removable flash media, floppy disk, etc. In some embodiments, less devices or other devices are connected to the system through the system bus 182 or with other input-output connections/arrangements as known in the industry. Examples of these devices include printers; graphics tablets; joysticks; and communications adapters such as modems and Ethernet adapters. In such, any of the prior devices 184/188/190/180/192 are optionally present.

Various components of the system for recovering precious metals 5 are controlled by the controller 40 such as the pumps 50/60, the power supply 10, the valves 52/62, and the electrode moving mechanism(s) 17. For example, the controller 40 instructs the valve 62 to open and the pump 60 to initiate exit flow.

In systems 5 in which a wide-area connection or connection to other system is needed, the network interface 180 connects the computer-based system to the network 110 through a link 178 which is, preferably, a high speed link such as a cable broadband connection, a Digital Subscriber Loop (DSL) broadband connection, a T1 line, or a T3 line.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for producing a hybrid gas, the system comprising:
a pressure vessel containing in its interior a feedstock;
at least one set of electrodes between which an electric arc is formed, each of the at least one set of electrodes within the pressure vessel and submerged within the feedstock;
means for passing of the feedstock through a plasma of the electric arc, thereby converting a portion of the feedstock into an arc-produced gas;
means for collecting the arc-produced gas; and
means for mixing the arc-produced gas with at least one supplementary fluid to produce a hybrid gas.

2. The system for producing a hybrid gas of claim 1, wherein the means for collecting further comprises liquefaction of the arc-produced gas.

3. The system for producing a hybrid gas of claim 1, wherein the at least one supplementary fluid includes at least one of propane, propylene, natural gas, methylacetylene, propadiene, naptha, synthetic natural gas, and hydrogen.

4. The system for producing a hybrid gas of claim 2, wherein the at least one supplementary fluid includes at least one of liquid propane, liquid propylene, liquid natural gas, liquid naptha, liquid synthetic natural gas, and liquid hydrogen.

5. The system for producing a hybrid gas of claim 1, wherein the hybrid gas includes at least 10% of the arc-produced gas by volume.

6. The system for producing a hybrid gas of claim 1, wherein the hybrid gas includes approximately 50% of the arc-produced gas by volume.

7. The system for producing a hybrid gas of claim 1, wherein the feedstock is oil.

8. The system for producing a hybrid gas of claim 1, wherein the feedstock is used motor oil.

9. The system for producing a hybrid gas of claim 1, wherein the feedstock is cooking oil.

10. The system for producing a hybrid gas of claim 1, wherein the feedstock is vegetable oil.

11. The system for producing a hybrid gas of claim 1, wherein the feedstock is used vegetable oil.

12. The system for producing a hybrid gas of claim 1, wherein the feedstock is water-based.

13. The system for producing a hybrid gas of claim 12, wherein the feedstock is sewerage.

14. A method for producing a hybrid gas, the method comprising:
putting a feedstock into a pressure vessel;
forming an electric arc between at least one pair of electrodes that are within the pressure vessel and submerged within the feedstock;
circulating the feedstock through a plasma of the electric arc, thereby converting a portion of the feedstock into an arc-produced gas;
collecting the arc-produced gas; and
mixing the arc-produced gas with at least one supplementary fluid to produce a hybrid gas.

15. The method of claim 14, wherein the at least one supplementary fluid includes at least one of propane, propylene, natural gas, methylacetylene, propadiene, naptha, synthetic natural gas, and hydrogen.

16. The method of claim 14, wherein the hybrid gas includes at least 10% of the arc-produced gas by volume.

17. The method of claim 14, wherein the hybrid gas includes approximately 50% of the arc-produced gas by volume.

18. The method of claim 14, wherein the feedstock is oil.

19. The method of claim 14, wherein the feedstock is sewerage.

20. An apparatus for producing a hybrid gas, the apparatus comprising:
a pressure vessel;
at least one pair of electrodes between which an electric arc is formed, each of the at least one pair of electrodes within the pressure vessel;
means for passing of a feedstock through a plasma of the electric arc, thereby converting a portion of the feedstock into an arc-produced gas;
means for collecting the arc-produced gas; and
means for mixing the arc-produced gas with at least one supplementary fluid to produce a hybrid gas;
whereas the feedstock is selected from the group consisting of a water-based fluid, sewerage, oil, cooking oil, used cooking oil, motor oil, used motor oil, vegetable oil, and used vegetable oil; and the at least one supplementary fluid is at least one of the group consisting of propane, propylene, natural gas, methylacetylene, propadiene, naptha, synthetic natural gas, and hydrogen.
